(19) United States
(12) Patent Application Publication
(10) Pub. No.: US 2001/0017324 A1
(43) Pub. Date: Aug. 30, 2001

(54) TWO PIECE GUIDED NOZZLE ASSEMBLY FOR A FUEL INJECTOR

(76) Inventors: DANA R. COLDREN, FAIRBURY, IL (US); GREGORY W. HEFLER, CHILLICOTHE, IL (US); ALAN R. STOCKNER, METAMORA, IL (US)

Correspondence Address: MCNEIL LIELL MCNEIL & HARPER, 511 S MADISON ST, BLOOMINGTON, IN, 47402

(21) Appl. No.: 09/258,712

(22) Filed: Feb. 26, 1999

(51) Int. Cl. F02M 61/00

(52) U.S. Cl. 239/533.2; 239/533.3; 239/533.9; 239/533.11; 123/533

(57) ABSTRACT

A fuel injector nozzle assembly comprises a lower tip component which includes a first locating surface. The lower tip component defines a lower guide bore with a first centerline and a nozzle outlet. The nozzle assembly also includes an upper tip component which is in contact with the lower tip component. The upper tip component includes a second locating surface and defines an upper guide bore with a second centerline. The first centerline is concentrically coupled with the second centerline by an interaction of the first locating surface with the second locating surface. A needle valve member includes an upper guide portion that is positioned in the upper guide bore and a lower guide portion that is positioned in the lower guide bore. The needle valve member is moveable between an open position, in which the nozzle outlet is open, and a closed position, in which the nozzle outlet is blocked.

### TECHNICAL FIELD

The present invention relates generally to fuel injector nozzle assemblies, and more particularly to fuel injectors having a multi-component nozzle assembly with a dual guided needle valve member.

### BACKGROUND ART

Traditional fuel injector nozzle assemblies utilize a one piece tip portion and a one piece valve member. However, these one piece tips are both difficult and expensive to manufacture because a heart shaped internal nozzle chamber had to be ECM machined out of their interior. In addition, satisfactory grinding of the needle seat is difficult, at least in part due to its location deep within the tip component. One solution to these problems is the use of a two-piece tip having upper and lower tip portions. In these fuel injectors, a single guide portion of a valve member moves within a guide bore defined by the upper tip portion during an injection event. This guide portion is coupled to the seat in the lower tip portion via a counter bore coupling relationship between the two tip portions. While this concentric coupling has performed well, some fuel injectors could benefit from an even better alignment method.

For instance, in valve closing orifice (VCO) type nozzle assemblies, the valve member at least partially covers the nozzle outlet orifices when seated in the closed position. This is accomplished by locating the seat just above the nozzle outlet orifices. Thus, a flow restriction immediately adjacent the outlet orifices occurs when the valve member is in a partially open position. In some cases, when the engine is operating at idle conditions, the valve member will not fully advance to the open position, and the nozzle outlet orifices will only be partially opened. Therefore, if the valve member is not properly aligned within the bore, it is possible that the flow area to each nozzle outlet orifice will not be equal, which will result in an uneven spray into the combustion chamber. In other words, the flow restriction adjacent the orifices may be different around the centerline of the nozzle tip component. The resulting uneven spray will undermine combustion. While the existing fuel injectors have performed well despite the possibility of this problem, engineers are always seeking a means to increase uniformity of fuel spray at idle engine operating conditions.

The present invention is directed to overcoming one or more of the problems described above and to improving uniformity of spray, especially when the nozzle outlets are only partially open.

### DISCLOSURE OF THE INVENTION

A fuel injector nozzle assembly comprises a lower tip component which includes a first locating surface. The lower tip component defines a lower guide bore with a first centerline and a nozzle outlet. The nozzle assembly also includes an upper tip component which is in contact with the lower tip component. The upper tip component includes a second locating surface and defines an upper guide bore with a second centerline. The first centerline is concentrically coupled with the second centerline by an interaction of the first locating surface with the second locating surface. The nozzle assembly also includes a needle valve member which comprises an upper guide portion that is positioned in the upper guide bore and a lower guide portion that is positioned in the lower guide bore. The needle valve member is moveable between an open position, in which the nozzle outlet is open, and a closed position, in which the nozzle outlet is blocked.

### BRIEF DESCRIPTION OF THE DRAWINGS

FIG. 1 is a diagrammatic sectioned front view of a two piece nozzle assembly according to the present invention.

FIG. 2 is a diagrammatic top sectioned view through the nozzle assembly of FIG. 1 as viewed along figure lines 2-2.

FIG. 3 is a diagrammatic sectioned front view of a two piece nozzle assembly according to another embodiment of the present invention.

FIG. 4 is a diagrammatic sectioned front view of a two piece nozzle assembly according to still another embodiment of the present invention.

### BEST MODE FOR CARRYING OUT THE INVENTION

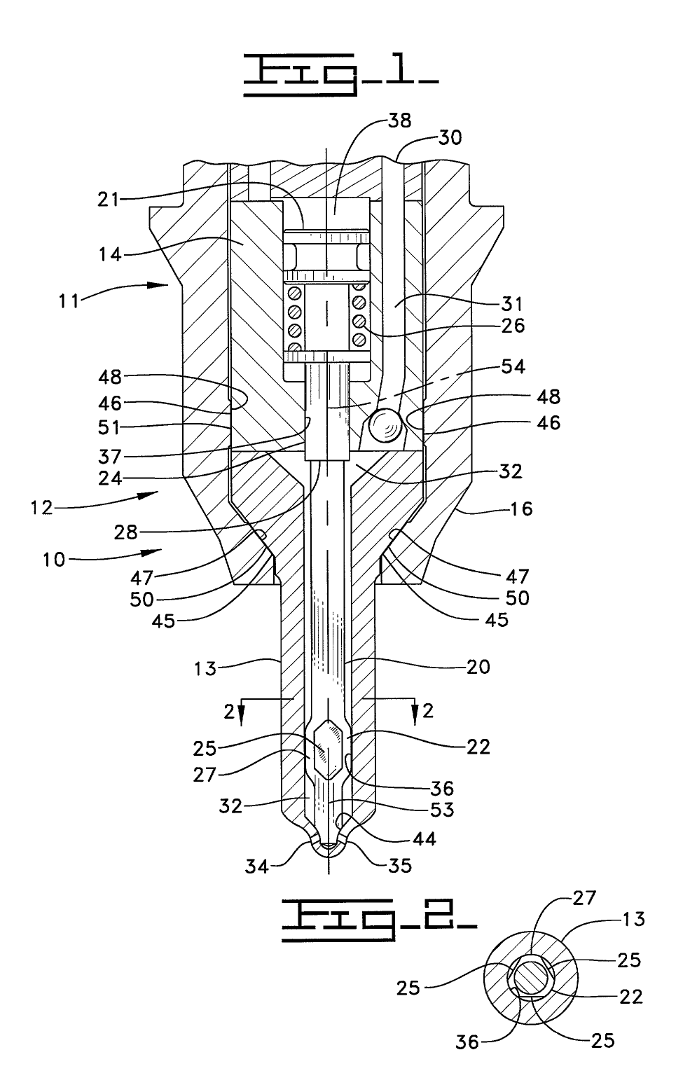

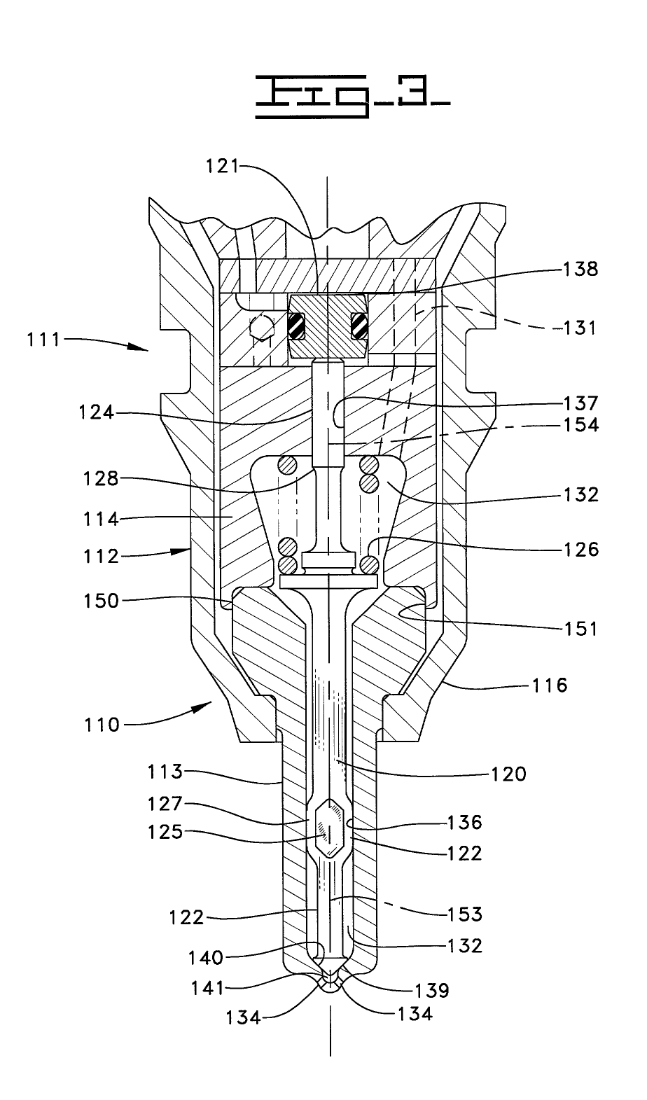

Referring now to FIGS. 1 and 2 there is shown a diagrammatic representation of a fuel injector nozzle assembly 10 according to the preferred embodiment of the present invention. Fuel injector nozzle assembly 10 is preferably a valve covering orifice (VCO) nozzle, and is a portion of a fuel injector 11. Included in fuel injector 11 is an injector body 12 that contains various components that are positioned as they would be just prior to an injection event. In particular, injector body 12 includes an upper tip component 14, a lower tip component 13, and a casing 16. Upper tip component 14 defines a high pressure fuel passage 30 and includes a cylindrical cavity containing a biasing spring 26. During an injection event, pressurized fuel travels from a fuel pressurization chamber (not shown) to a nozzle chamber 32 through a nozzle supply passage 31 from high pressure fuel passage 30. Biasing spring 26 acts to bias a needle valve member 20 to a closed position.

Needle valve member 20 includes a closing hydraulic surface 21 and an opening hydraulic surface 28. Closing hydraulic surface 21 is exposed to fluid pressure in a needle control chamber 38, which is alternately open to a source of high and low pressure via plumbing not shown. Thus, the needle valve member is a direct control needle valve that has the ability to open and close a nozzle outlet 34 during an injection event, even when injection pressure is sufficient to overcome biasing spring 26. Opening hydraulic surface 28 is exposed to fuel pressure within nozzle chamber 32. Needle valve member 20 is moveable between an upward, open position in which nozzle outlet 34 is open and a downward, closed position in which nozzle outlet 34 is closed. Needle valve member 20 also includes an upper guide portion 24 and a lower guide portion 22. Lower guide portion 22 defines a plurality of partial cylindrical portions 27 which alternate with a plurality of equally spaced flat surfaces 25 about needle valve member 20. In the illustrated embodiment, three equally spaced partial cylindrical portions 27 provide guidance to needle valve member 20 in the two lateral degrees of freedom. Those skilled in the art will appreciate that other geometrical configurations could be used to produce the same desired results. During an injection event, lower guide portion 22 can move within a lower guide bore 36 which is defined by lower tip component 13 to have a lower tip centerline 53. Similarly, upper guide portion 24 can move within an upper guide bore 37 during an injection event. Upper guide bore 37 is defined by upper tip component 14 to have an upper tip centerline 54. When needle valve member 20 is in the open position, fuel in nozzle chamber 32 can exit fuel injector 11 through nozzle outlet 34 which includes a plurality of spray orifices 35 that are distributed about lower tip centerline 53.

Upper guide portion 24 and lower guide portion 22 should be separated by a sufficient distance to prevent binding in needle valve member 20 due to any misalignment of their respective centerlines. In fuel injectors using a VCO nozzle, uniformity of fuel flow is especially important during partially open conditions, such as at idle. Recalling, in a VCO nozzle, such as that shown in FIG. 1, opening hydraulic surface 28 at least partially covers spray orifices 35 when needle valve member 20 is in the closed position. This occurs because the needle seat is just above the outlet orifices. When the engine is operating at idle operating conditions, needle valve member 20 will not completely advance to the open position, but will instead only partially open spray orifices 35. In this partially open position, a flow restriction exists in the area between valve member 20 and the valve seat 44. Therefore, if needle valve member 20 is not concentrically aligned with a valve seat 44 when partially open, there will not be uniform flow from all spray orifices 35. In other words, flow area to spray orifices 35 could vary substantially between one another.

Returning to nozzle assembly 10, an outer surface 46 of upper tip component 14 defines an upper tip locating surface 51 which is a right cylinder. Upper tip locating surface 51 is machined to a tight clearance with a cylindrical contact surface 48 of casing 16. Similarly, an outer surface 45 of lower tip component 13 defines a lower tip locating surface 50 which is frustoconical and is machined to seat into a counterpart which is a frustoconical contact surface 47 of casing 16. In this manner, casing 16 can act as an interaction between upper tip component 14 and lower tip component 13 which will concentrically couple upper tip centerline 54 to lower tip centerline 53 when the two tip components are in contact as shown in FIG. 1. Those skilled in the art will appreciate that contact surfaces are machined to be perpendicular to the centerline. Concentric coupling of upper tip centerline 54 to lower tip centerline 53 should ensure that upper guide bore 37 is properly aligned to lower guide bore 36. This coupling will result in the concentric alignment of upper guide portion 24 and lower guide portion 22 as well as various other seats and components of nozzle assembly 10.

Upper guide bore 37 and upper tip locating surface 51 are preferably machined in a single chucking so that respective centerlines defined by these components are as concentric as possible. It is important for optimization of injector performance that a tight tolerance exist between upper guide portion 24 and upper guide bore 37. This tolerance must be tight enough to ensure proper sealing in upper guide bore 37, while not so tight as to prevent proper movement of upper guide portion 24 within upper guide bore 37. Once upper tip component 14 is machined to these tight tolerances, it is match fit to other components to ensure a running clearance. For this reason, upper tip component 14 is considered a match clearance. While this clearance could be achieved in a different manner, cost and other considerations known in the art compel making upper guide bore 37 and upper tip locating surface 51 a match clearance. Conversely, the lower clearance, that of lower guide portion 36 within lower tip component 13, can be accomplished through conventional machining techniques. In other words, clearance must be only sufficiently tight that a valving surface of needle valve member 20 is closely aligned with valve seat 44 on lower tip component 13 for proper spray characteristics.

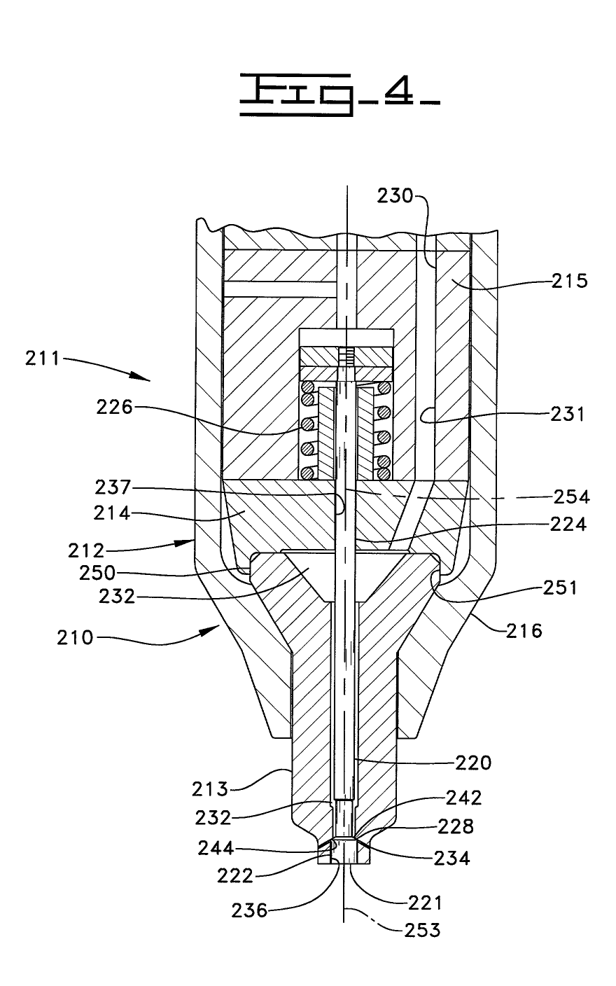

Referring now to FIG. 3 there is shown a fuel injector nozzle assembly 110 according to another embodiment of the present invention. In this embodiment, fuel injector nozzle assembly 110 is a mini-sac type nozzle and is a portion of a fuel injector 111. Included in fuel injector 111 is an injector body 112 that contains various components that are positioned as they would be just prior to an injection event. In particular, injector body 112 includes an upper tip component 114, a lower tip component 113, and a casing 116. During an injection event, pressurized fuel travels from a fuel pressurization chamber (not shown) to a nozzle chamber 132 through a nozzle supply passage 131 which is defined by upper tip component 114. Upper tip component 114 includes a biasing spring 126 which acts to bias a needle valve member 120 to a closed position during an injection event.

Needle valve member 120 includes a closing hydraulic surface 121 and an opening hydraulic surface 128. As with the FIG. 1 embodiment, closing hydraulic surface 121 is exposed to fluid pressure in a needle control chamber 138 while opening hydraulic surface 128 is exposed to fluid pressure within nozzle chamber 132. Thus, FIG. 3 also shows a direct control needle valve. Needle valve member 120 is moveable between an upward, open position in which nozzle outlet 134 is open, and a downward, closed position, in which nozzle outlet 134 is closed. Recall that, unlike VCO nozzle assembly 10, shown in FIG. 1, nozzle assembly 110 is a mini-sac type nozzle. Therefore, conical valve surface 139 of needle valve member 120 does not cover nozzle outlet 135 when needle valve member 120 is in the closed position. Rather, when needle valve member 120 is in the closed position, a conical valve surface 139 of needle valve member 120 is seated at an outlet closing seat 140, located substantially above nozzle outlet 135. The result of this geometry is a dead space, or a mini-sac 141, which is located below needle valve member 120 and in fluid contact with nozzle outlet 135 when conical valve surface 139 is seated.

Needle valve member 120 includes an upper guide portion 124, a lower guide portion 122, and a number of flat surfaces 125. Upper guide portion 124 moves within an upper guide bore 137 which is defined by upper tip component 114 to have an upper tip centerline 154. Similarly, lower guide portion 122 moves within a lower guide bore 136 which is defined by lower tip component 113 to have a lower tip centerline 153. Lower guide portion 122 defines a plurality of partial cylindrical passages 127 which alternate about needle valve member 120 with flat surfaces 125. Lower tip centerline 153 and upper tip centerline 154 should be concentrically coupled to allow fuel injector 111 to function as desired. In other words, concentric alignment will prevent binding, lessen sensitivity to seat wear and ensure close concentric alignment between conical valve surface 139 and outlet closing seat 140. This coupling is achieved by the interaction of upper tip component 114 with lower tip component 113.

Upper tip component 114 includes an upper tip locating surface 151, which in this embodiment is a locating bore. Lower tip component 113 includes a lower tip locating surface 150 which is a cylindrical protrusion in this embodiment. A clearance positioning of lower tip locating surface 150 and upper tip locating surface 151 acts as the interaction which couples lower tip centerline 153 to upper tip centerline 154 in this embodiment of the present invention. In this embodiment, a fit between the cylindrical protrusion, or lower tip locating surface 150, and the locating bore, or upper tip locating surface 151, acts to concentrically couple lower tip centerline 153 to upper tip centerline 154.

Referring now to FIG. 4, another embodiment of the present invention is shown which is substantially similar to the embodiment shown in FIG. 3, with the exception that nozzle assembly 210 includes an outwardly opening needle valve member 220. Fuel injector 211 includes an injector body 212 that contains various components that are positioned as they would be just prior to an injection event. In particular, injector body 212 includes a spring cage 215, an upper tip component 214, a lower tip component 213, and a casing 216. Spring cage 215 defines a high pressure fuel passage 230 and includes a biasing spring 226. During an injection event, pressurized fuel travels from a fuel pressurization chamber (not shown) to a nozzle chamber 232 through a nozzle supply passage 231 from high pressure fuel passage 230. Biasing spring 226 acts to bias needle valve member 220 to a closed inward, or upward, position.

Needle valve member 220 is moveable between an outward, open position in which nozzle outlet 234 is open, and a closed, inward position, in which nozzle outlet 234 is closed. When needle valve member 220 is in the inward, closed position a conical valve surface 242 of needle valve member 220 is in contact with a conical valve seat 244 of lower tip component 213. The respective slopes of surfaces 242 and 244 are preferably slightly different so that sealing occurs in a conventional manner. Due in part to flow considerations, sealing preferably occurs by the annular corner portion of surface 244 coming in contact in a circular line portion of conical valve surface 242. Needle valve member 220 also includes a closing hydraulic surface 221 which is exposed to fluid pressure in the combustion space and an opening hydraulic surface 228 which is exposed to fluid pressure in nozzle chamber 232.

Needle valve member 220 includes an upper guide portion 224 and a lower guide portion 222. Upper guide portion 224 moves within an upper guide bore 237 which is defined by upper tip component 214 to have an upper tip centerline 254. Similarly, lower guide portion 222 moves within a lower guide bore 236 which is defined by lower tip component 213 to have a lower tip centerline 253. Lower tip centerline 253 and upper tip centerline 254 should be concentrically coupled to allow fuel injector 211 to function properly, i.e. concentrically align the valving surfaces and prevent binding. As with the embodiment of FIG. 3, this coupling is achieved by the interaction of upper tip component 214 with lower tip component 213.

As in the FIG. 3 embodiment, upper tip component 214 includes an upper tip locating surface 251 which defines a locating bore. Lower tip component 213 includes a lower tip locating surface 250 which is a cylindrical protrusion. As with the embodiment shown in FIG. 3, a clearance positioning of lower tip locating surface 250 and upper tip locating surface 251 acts as the interaction which couples lower tip centerline 253 to upper tip centerline 254. In other words, a clearance of the cylindrical protrusion on lower tip component 213 and the locating bore in upper tip component 214 acts to concentrically couple lower tip centerline 253 to upper tip centerline 254.

Industrial Applicability

Referring now to FIG. 1, prior to the start of an injection event, needle valve member 20 is seated in its closed position. At the initiation of the injection event, high pressure fuel passage 30 is exposed to a source of high pressure fuel. As the injection event progresses, the pressure of fuel within nozzle chamber 32 begins to rise. The high pressure fuel flows into nozzle chamber 32 through nozzle supply passage 31 via high pressure fuel passage 30. Because needle valve member 20 is still seated in its closed position the high pressure fuel entering nozzle chamber 32 is unable to spray into the combustion chamber and, therefore, the pressure within nozzle chamber 32 continues to rise.

Once the fuel pressure within nozzle chamber 32 exceeds the valve opening pressure, and needle control chamber 38 is exposed to low pressure to relieve the pressure force on closing hydraulic surface 21, the pressure force acting on opening hydraulic surface 28 of needle valve member 20 is sufficient to move needle valve member 20 upward toward the open position against the action of biasing spring 26. When the engine is operating at an idle operating condition, needle valve member 20 does not advance completely to the open position. As needle valve member 20 advances toward the open position, nozzle chamber 32 becomes fluidly connected to the combustion chamber by the partial opening of spray orifices 35. Thus the concentric alignment provided by the present invention assures uniform spray event under partially opened conditions.

The preferred embodiment of the present invention, shown in FIG. 1, can create a more uniform fuel spray at idle operating conditions in VCO nozzle assembly 10 by providing better concentric alignment of needle valve member 20 within upper guide bore 37 and lower guide bore 36. By combining a double guided valve member with the use of an interaction between upper tip locating surface 51 and lower tip locating surface 50 to couple upper tip centerline 54 with lower tip centerline 53, the present invention can more effectively align upper guide portion 24 within upper guide bore 37 and lower guide portion 22 within lower guide bore 36. The positioning of lower guide portion 22 away from seat 44 can also aid in creating uniform fuel spray at idle conditions by helping to create a uniform ring of fuel flowing toward nozzle outlet 34 from nozzle chamber 32. Each injection event is ended by opening needle control chamber 39 to high pressure which will cause needle valve member 20 to move toward the downward, closed position.

Referring now to the FIG. 3 embodiment, once the fuel pressure within nozzle chamber 132 exceeds the valve opening pressure, and needle control chamber 139 is exposed to low pressure which will relieve the pressure force on closing hydraulic surface 121, the pressure force acting on opening hydraulic surface 128 of needle valve member 120 is sufficient to move needle valve member 120 against the action of biasing spring 126. When the engine is operating at an idle operating condition, needle valve member 120 does not always advance completely to the open position. The injection event is ended in a direct control needle valve manner by reconnecting needle control chamber 139 to a source of high pressure.

Referring now to the embodiment shown in FIG. 4, once the fuel pressure within nozzle chamber 232 exceeds the valve opening pressure, the pressure force acting on opening hydraulic surface 228 of needle valve member 220 is sufficient to push needle valve member 220 downward and outward against the action of biasing spring 226. Needle valve member 220 is not a direct control needle valve as shown in FIGS. 1 and 3, and is instead assisted in closing by the residual pressure within the combustion space.

Certain characteristics of needle valve member 20 are determined by various engineering considerations. For instance, as needle valve member 20 is made more rigid and concurrently as the clearances in upper and lower guide bores 37,36 are machined to be more tight, there is a greater likelihood that needle valve member will bind. Further, the flexibility of needle valve member 20 and the separation of upper and lower guide portions 24, 22 should be balanced to allow needle valve member to properly open and close nozzle outlet 34. This relationship should be determined while considering that even under the best circumstances there could be some minute residual concentricity misalignment within the nozzle assembly. Another consideration is the motivation to make lower guide portion 22 as close a possible to valve seat 44 in order to ensure a proper alignment at seat 44, where a flow restriction will occur. This consideration should be counter-balanced with the desirability that flow be in a uniform cylinder or ring adjacent spray orifices 35, which is undermined by placing flat surfaces 25 of lower guide portion 22 too close to nozzle outlet 34. Therefore, lower guide portion 22 must be sufficiently far from nozzle outlet 34 to ensure uniform flow while being placed sufficiently close to ensure proper alignment.

It should be understood that the above description is intended only to illustrate the concepts of the present invention, and is not intended to in any way limit the potential scope of the present invention. For instance, while the alternate embodiments show the upper tip locating surface defining a locating bore and the lower tip locating surface defining a cylindrical protrusion, it should be appreciated that this relationship could be reversed to achieve the same coupling results. Further, while the upper centerline and lower centerline were coupled using two disclosed interactions, it should be appreciated that various other geometric shapes and relations could be substituted as the interaction to couple these two centerlines. Additionally, while the illustrated embodiments show flow past the lower guide portion achieved by machining of flat surfaces on the lower guide portion, any other suitable connection could be used. Further, while the present invention shows utilizes three flat surfaces, the use of a greater number of flat surfaces could work equally well. Thus, various modifications could be made without departing from the intended spirit and scope of the invention as defined by the claims below.

1. A fuel injector nozzle assembly comprising:
a lower tip component having a first locating surface and defining a lower guide bore with a first centerline and a nozzle outlet;
an upper tip component in contact with said lower tip component and having a second locating surface, and defining an upper guide bore with a second centerline;
a needle valve member having an upper guide portion positioned in said upper guide bore, and having a lower guide portion positioned in said lower guide bore, and being movable between an open position in which said nozzle outlet is open, and a closed position in which said nozzle outlet is blocked; and
said first centerline being concentrically coupled to said second centerline via an interaction of said first locating surface with said second locating surface.

2. The fuel injector nozzle assembly of claim 1 wherein said lower tip component has a first outer surface, and said first locating surface is an annular portion of said first outer surface; and
said upper tip component has a second outer surface, and said second locating surface is an annular portion of said second outer surface.

3. The fuel injector nozzle assembly of claim 1 wherein said first locating surface is frustoconical; and
said second locating surface is cylindrical.

4. The fuel injector nozzle assembly of claim 1 wherein said interaction is a casing component in contact with said first locating surface and said second locating surface.

5. The fuel injector nozzle assembly of claim 1 wherein one of said first locating surface and said second locating surface defines a locating bore;
the other of said first locating surface and said second locating surface including a cylindrical protrusion; and
said interaction being a tight clearance positioning of said cylindrical protrusion in said locating bore.

6. The fuel injector nozzle assembly of claim 1 wherein said upper guide portion is cylindrical; and
said upper guide portion is a matched clearance fit with said upper guide bore.

7. The fuel injector nozzle assembly of claim 1 wherein said lower guide portion includes a plurality of partial cylindrical portions distributed around a needle centerline.

8. The fuel injector nozzle assembly of claim 1 wherein said nozzle outlet includes a plurality of spray orifices distributed around said first centerline; and
a portion of said needle valve member at least partially covers one end of said spray orifices when in said closed position.

9. The fuel injector nozzle assembly of claim 1 wherein said upper tip component, said lower tip component and said needle valve member define a nozzle chamber; and
said needle valve member includes an opening hydraulic surface exposed to fluid pressure in said nozzle chamber.

10. The fuel injector nozzle assembly of claim 1 wherein said needle valve member includes a closing hydraulic surface exposed to fluid pressure outside said lower tip component.

11. A fuel injector valve closing orifice nozzle assembly comprising:
a lower tip component having a first annular locating surface and an annular needle valve seat, and defining a lower guide bore and a plurality of spray orifices, and said first annular locating surface, said annular needle valve seat and said lower guide bore sharing a common first centerline, and said spray orifices being distributed around said first centerline;
an upper tip component in contact with said lower tip component and having a second annular locating surface, and defining an upper guide bore, and said second annular locating surface and said upper guide bore sharing a common second centerline;
a needle valve member having an upper guide portion positioned in said upper guide bore, and having a lower guide portion positioned in said lower guide bore, and being movable between an open position in which said spray orifices are open, and a closed position in which one end of said spray orifices is at least partially covered; and
said first centerline being concentrically coupled to said second centerline via an interaction of said first annular locating surface with said second annular locating surface.

12. The fuel injector nozzle assembly of claim 11 wherein at least one of said first annular locating surface and said second annular locating surface define a cylinder.

13. The fuel injector nozzle assembly of claim 12 wherein said upper tip component, said lower tip component and said needle valve member define a nozzle chamber; and
said needle valve member includes an opening hydraulic surface exposed to fluid pressure in said nozzle chamber.

14. The fuel injector nozzle assembly of claim 13 wherein one of said upper guide portion and said lower guide portion define a cylinder.

15. The fuel injector nozzle assembly of claim 14 wherein said one of said upper guide portion and said lower guide portion is a matched clearance fit with a corresponding one of said upper guide bore and said lower guide bore.

16. A fuel injector nozzle assembly comprising:
a lower tip component having a first annular locating surface and an annular needle valve seat, and defining a lower guide bore and a plurality of spray orifices, and said first annular locating surface, said annular needle valve seat and said lower guide bore sharing a common first centerline, and said spray orifices being distributed around said first centerline;
an upper tip component in contact with said lower tip component and having a second annular locating surface, and defining an upper guide bore, and said second annular locating surface and said upper guide bore sharing a common second centerline;
a needle valve member having an upper guide portion positioned in said upper guide bore, and having a lower guide portion positioned in said lower guide bore, and being movable between an open position in which said spray orifices are open, and a closed position in which one end of said spray orifices is at least partially covered; and
said first centerline being concentrically coupled to said second centerline via an interaction of said first annular locating surface with said second annular locating surface, and said interaction is a casing component in contact with said first locating surface and said second locating surface.

17. The fuel injector nozzle assembly of claim 16 wherein said first locating surface is cylindrical; and
said second locating surface is frustoconical.

18. The fuel injector nozzle assembly of claim 17 wherein said upper tip component, said lower tip component and said needle valve member define a nozzle chamber; and
said needle valve member includes an opening hydraulic surface exposed to fluid pressure in said nozzle chamber.

19. The fuel injector nozzle assembly of claim 18 wherein said lower guide portion includes at least three partial cylindrical portions distributed around a needle centerline.

20. The fuel injector nozzle assembly of claim 19 wherein said upper guide portion is separated from said lower guide portion by a first distance; and
said lower guide portion is separated from a lower end of said needle valve member by a second distance that is smaller than said first distance.
